(19) United States
(12) Patent Application Publication
(10) Pub. No.: US 2007/0214434 A1
(43) Pub. Date: Sep. 13, 2007

(54) User interface and navigation for portable electronic devices

(76) Inventor: Tobias Rydenhag, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/367,107

(22) Filed: Mar. 3, 2006

(51) Int. Cl. G06F 3/048

(52) U.S. Cl. 715/854

(57) ABSTRACT

An improved user interface for a portable electronic device that incorporates contextual navigation information with filter criteria to enable users to navigating through fewer views to achieve desired search results. The user interface enables a user to perform a search/filter by selecting a first filter level filter criterion and a contextual navigation filter criterion from the same view. A third data set is displayed when the filter is applied, thereby allowing the user to jump from a first level view to a third level view.

### TECHNICAL FIELD OF THE INVENTION

The present invention relates generally to portable electronic devices, and, more particularly, to a system and method for providing an improved user interface for portable electronic devices.

### DESCRIPTION OF THE RELATED ART

In recent years, portable electronic devices, such as mobile phones, personal digital assistants (PDA), mobile terminals, portable digital music players (e.g., iPods, mp3 players), etc. have grown and continue to grow in popularity. At least anecdotally, it can be said that everyone seems to have a mobile phone these days. As the popularity of portable electronic devices continues to grow, mobile phones and networks are being enhanced to provide services beyond voice services.

The growth in popularity of portable electronic devices has been driven by continued technological advancement, as well as by the demand from users of improved portable electronic devices. As portable electronic devices become smaller and storage capabilities become greater, users are finding it increasingly difficult to access the vast amount of information stored on their portable electronic devices. For example, a portable electronic device user trying to access one of the many songs stored on his portable digital music player or mobile phone may have to navigate through multiple layers of menus in order to find the desired song. The process of searching for the song can be time consuming and frustrating, especially because the displays on most portable electronic devices are limited in size as consumers are constantly in search of smaller and sleeker and portable electronic devices.

It would be desirable to have an improved user interface for portable electronic devices that provided easier access to the data stored therein.

### SUMMARY

One aspect of the present invention relates to a user interface for a portable electronic device. The user interface includes a first view for displaying a plurality of contextual navigation filter criteria and at least part of a first level data set representing a plurality of selectable first level filter criteria. The user interface also includes a second view for displaying the plurality of selectable contextual navigation filter criteria and at least part of a second level data set representing a plurality of selectable second level filter criteria. The user interface further includes a third view for displaying the plurality of selectable contextual navigation filter criteria and at least part of a third level data set representing a plurality of selectable third level filter criteria. In addition, the user interface includes a fourth view for displaying at least part of a fourth level data set. Also, the selection by a user of one of the plurality of second level filter criteria from the second view causes the user interface to display the third view, and the selection by a user of one of the plurality of second level filter criteria from the second view and at least one of the plurality of navigation filter criteria causes the user interface to display all or part of a subset of the third level data set resulting from application of the second level filter criterion and the navigation filter criterion.

According to another aspect, the selectable contextual navigation filter criteria provide the user with an identification of the type of data set being displayed.

According to another aspect, wherein the subset of the third level data set resulting from application of the second level filter criterion and the navigation filter criterion comprises the fourth level data set.

According to another aspect, the second level data set is a superset of the third level data set and the third level data set is a superset of the fourth level data set.

According to another aspect, the contextual navigation filter criteria comprise icons.

According to another aspect, at least three of the icons represent the first level data set, the second level data set and third level data set.

According to another aspect, the icons provide visual feedback relating to the view displayed.

According to another aspect, the icons are displayed linearly.

According to another aspect, the selection of one of the plurality of second level filter criteria and the selection of one of the plurality of navigation filter criteria are accomplished using different types of user input.

According to another aspect, the type of input for the selection of one of the plurality of navigation filter criteria is at least one of: a number key, a letter key or a touchscreen.

According to another aspect, the at least part of one of the data sets is stored locally in the portable electronic device.

According to another aspect, the at least part of one of the data sets is stored remotely on a remote computer readable medium accessible to the portable electronic device.

According to another aspect, the portable electronic device is at least one of: a portable digital music player, a mobile phone or a PDA.

According to another aspect, the displayed data is limited by at least one additional player statistics criterion.

According to another aspect, the additional player statistics criterion is at least one of: most played, not played, mood or rating.

Another aspect of the present invention relates to a program stored on a machine readable medium. The program is suitable for use in a portable electronic device and when the program is loaded in memory in the portable electronic device and executed, the program causes the portable electronic device to be configured at least in part: (a) to display a view of a plurality of general selection options and a plurality of contextual navigation selection options; (b) to receive a general selection and a contextual navigation selection from a user via a user interface; (c) to apply a filter to a plurality of data elements using information received from one of the general selection or the contextual navigation selection; (d) to apply a filter or a sort to the plurality of data elements using information received from the other of the general selection or the contextual navigation selection; and (e) to display at least one data element representing results achieved from performing (c) and (d).

According to another aspect, the selectable contextual navigation selection options provide the user with an identification of the type of data set being displayed.

According to another aspect, the contextual navigation selection options comprise icons.

According to another aspect, at least three of the icons represent at least three levels of data sets and wherein at least the third level is a subset of the second level.

According to another aspect, the icons provide visual feedback relating to the view displayed.

According to another aspect, the icons are displayed linearly.

According to another aspect, the general selection and the contextual navigation selection are received using different types of user input.

According to another aspect, the type of input for the contextual navigation selection is at least one of: a number key, a letter key or a touchscreen.

According to another aspect, at least one of the plurality of data elements is stored locally in the portable electronic device.

According to another aspect, at least one of the plurality of data elements is stored remotely on a remote computer readable medium accessible via the portable electronic device.

According to another aspect, the portable electronic device is at least one of: a portable digital music player, a mobile phone or a PDA.

According to another aspect, the displayed data is limited by at least one additional player statistics criterion.

According to another aspect, the additional player statistics criterion is at least one of: most played, not played, mood or rating.

According to another aspect, the selected filter criteria are applied to metadata associated with data files.

According to another aspect, the selection of an element of at least one data set causes the portable electronic device to open a data file.

According to another aspect, the data file is selected from the group consisting essentially of: audio files, image files, video files and combinations thereof.

Another aspect of the present invention relates to program stored on a machine readable medium. The program is suitable for use in a portable electronic device, and when the program is loaded in memory in the portable electronic device, the program improves navigation through a multilevel data set on a portable electronic device by causing the portable electronic device to be configured: to display a first view of at least part of a first level data set representing a plurality of selectable first level filter criteria; to receive a first level filter criteria selection; to use the first level filter criteria selection to create a second level data set for at least partial display in a second view; to receive a second level filter criteria selection; to use the second level filter criteria selection to create a third level data set for at least partial display in a third view; to display a set of contextual navigation icons in the first view, the second view and the third view, wherein the set of contextual navigation icons comprises a separate icon for each of the views; and to modify the appearance of the contextual navigation icons for each of the views to provide a visual identification of the data set that is displayed.

According to another aspect, the program causes the portable electronic device to be further configured to use the third level filter criteria selection to create a fourth level data set for at least partial display in a fourth view.

According to another aspect, the program causes the portable electronic device to be further configured to display the set of contextual navigation icons in the fourth view.

According to another aspect, the set of contextual navigation icons is displayed in a linear pattern.

According to another aspect, the appearance of the contextual navigation icons comprises at least one of: highlighting one of the icons, changing the color of one of the icons, making one of the icons larger, or placing one of the icons within a geometric shape.

According to another aspect, the portable electronic device is at least one of: a portable digital music player, a mobile phone or a PDA.

Another aspect of the present invention relates to method for displaying data elements on a portable electronic device. The method includes (a) displaying a view of a plurality of general selection options and a plurality of contextual navigation selection options; (b) receiving a general selection and a contextual navigation selection from a user via a user interface; (c) applying a filter to a plurality of data elements using information received from one of the general selection of the contextual navigation selection; (d) applying a filter or a sort to the plurality of data elements using information received from the other of the general selection or the contextual navigation selection; and (e) displaying at least one data element representing results achieved from performing (c) and (d).

Another aspect of the present invention relates to method for improving navigation through a multilevel data set on a portable electronic device. The method includes displaying a first view of at least part of a first level data set representing a plurality of selectable first level filter criteria; receiving a first level filter criteria selection; using the first level filter criteria selection to create a second level data set for at least partial display in a second view; receiving a second level filter criteria selection; using the second level filter criteria selection to create a third level data set for at least partial display in a third view; displaying a set of contextual navigation icons in the first view, the second view and the third view, wherein the set of contextual navigation icons comprises a separate icon for each of the views; and modifying the appearance of the contextual navigation icons for each of the views to provide a visual identification of the data set that is displayed.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a representation of a plurality of views for a prior art user interface for a portable electronic device;

FIG. 2 is a representation of a plurality of views for a user interface for a portable electronic device according to an aspect of the present invention;

FIG. 3 is a representation of a plurality of views for a user interface for a portable electronic device according to another aspect of the present invention;

FIG. 4 is a diagrammatic illustration of an exemplary portable electronic device on which the present invention is carried out;

FIG. 5 is a flow chart illustrating a method according to the present invention for displaying data elements on a portable electronic device; and

FIG. 6 is a flow chart illustrating a method according to the present invention for improving navigation through a multilevel data set on a portable electronic device.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As used herein, the term “electronic equipment” includes portable electronic devices, such as portable digital music devices (e.g., iPods, mp3 players, etc.) and portable radio communication devices. The term portable radio communication device, which hereinafter is referred to as a mobile phone, a mobile device, a mobile radio terminal or a mobile terminal, includes all devices, including, but not limited to, mobile telephones, pagers, communicators, i.e., electronic organizers, smartphones, personal digital assistants (PDAs), or the like. A portable radio communication device may also be a portable digital music device.

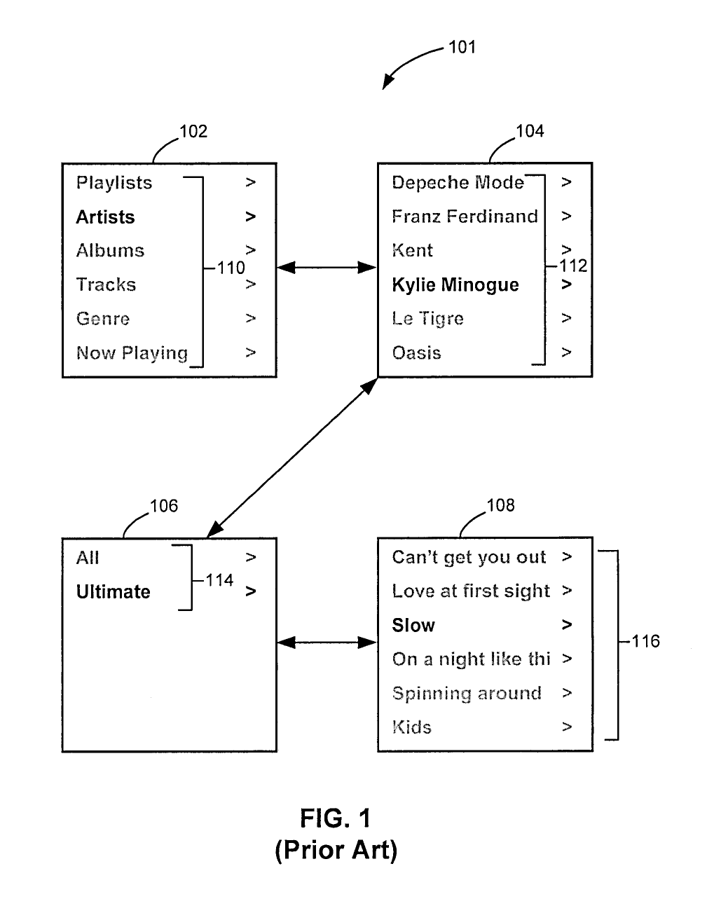

Referring initially to FIG. 1, a representation of a plurality of views (collectively designated 101) of a prior art user interface for a portable electronic device is provided. The user interface shown in FIG. 1 is typical of an ipod user interface. As but one example, the views of the user interface may be shown on the display or the like of a portable electronics device. The interface includes a first view 102 for displaying a first level data set 110. The elements of the first level data set 110 function as selectable filter criteria to help a user navigate through a data set, which typically includes digital music files, but may also include digital video files and/or digital image files. The data set includes files that are typically stored locally in memory on the portable electronic device. In addition, each of the files may have one or more metadata tags associated therewith. The metadata associated with the files contains information about the files, such as titles of songs, albums, artists, genres, etc. The portable electronic device thus searches the metadata associated with the files when it receives a filter or sort request from a user.

In use, the first view 102 displays a first level data set 110 that includes general selection options for the user. Some, if not all, of the elements displayed in the first level data set 110 are filter criteria for the portable electronic device. To initiate a filter and begin the process of locating a desired song, the user selects one of the filter criteria in the first level data set 110. The filter criteria in the first level data set 110 are also referred to herein as “general selection options.”

The selection of a filter criterion from the first level data set 110 causes the portable electronic device to display the second view 104 with a second level data set 112. The second level data set 112 may either be a sorted display of the first level data set 110 or it may be a subset of the first level data set 110. In either case, the second level data set 112 is associated with the selected filter criterion from the first level data set 110. Like the first level data set 110, the second level data set 112 also includes displayed elements that act as filter criteria for the portable electronic device. Also like the first level data set 110, the filter criteria in the second level data set 112 are also referred to herein as “general selection options.”

The selection of a filter criterion from the second level data set 112 causes the portable electronic device to display the third view 106 with a third level data set 114. The third level data set 114 is a subset of the second level data set 112 based on the selected filter criterion from the second level data set 112. Like the first level data set 110 and the second level data set 112, the third level data set 114 also includes displayed elements that act as filter criteria for the portable electronic device. Also like the first level data set 110 and second level data set 112, the filter criteria in the third level data set 114 are also referred to herein as “general selection options.”

The selection of a filter criterion from the third level data set 114 causes the portable electronic device to display the fourth view 108 with a fourth level data set 116. Whereas the first level data set 110, second level data set 112 and third level data set 114 each included categories or groups, the fourth level data set of FIG. 1 includes singular data elements. In other words, while the other data sets included lists of categories and groups of songs, the fourth level data set includes a list of songs. A user can play a song by selecting it from the fourth level data set 116.

The user interface also allows the user to return to the prior view at any time, e.g., by a user providing appropriate inputs to the portable electronic device. Thus, the user can navigate both forwards and backwards using the user interface, but the user can only move one level at a time.

The requirement that the user navigate one level at a time is a disadvantage of the prior art user interfaces. For example, the user cannot use the prior art user interface of FIG. 1 to skip from the second view 104 to the fourth view 108. Moreover, as the number of views size of data sets increase, it may be desirable to provide information to the user about where he or she is located within the navigational structure of the user interface. More specifically, it may be desirable to provide the user with a graphical indication of the type of data set that is being displayed as well as how the displayed data set relates to the totality of the data available to the user via the portable communication device.

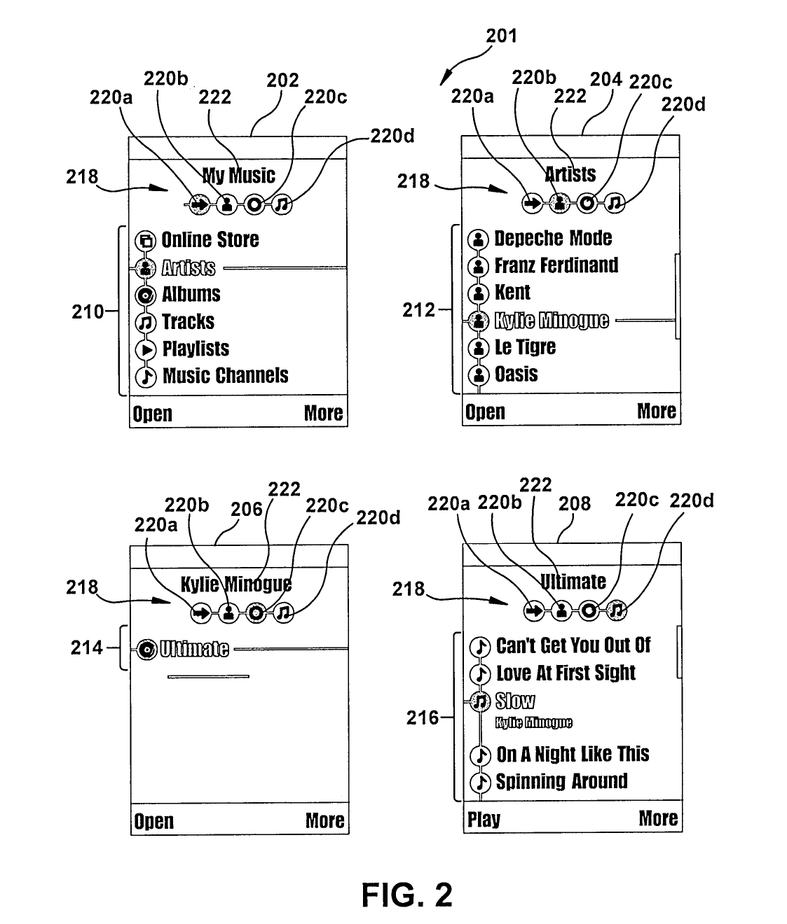

Turning next to FIG. 2, a representation of a plurality of views (collectively 201) for a user interface for a portable electronic device according to an aspect of the present invention is provided. The user interface of FIG. 2 is capable of navigation between levels and filtering based on user selected criteria. The user interface includes a first view 202 for displaying a first level data set 210. The elements of the first level data set 210 function as selectable filter criteria to help a user navigate through a data set, which typically includes digital music files, but may also include digital video files and/or digital image files. The data set includes files that are typically stored locally in memory on the portable electronic device, such as a portable digital music player, a mobile phone or a PDA. In addition the data set may be stored remotely on a remote computer readable medium that is accessible to the portable electronic device, such as via the Internet, mobile phone network or the like.

In addition, the files preferably have one or more tags (metadata or the like) associated therewith. The tags associated with the files contain information about the files. In the case of songs or music videos, for example, the tags may contain information such as titles of songs, albums, artists, genres, etc. The portable electronic device thus searches the metadata associated with the files when it receives a filter or sort request from a user.

The user interface according to the present invention includes a first view 202 wherein the portable electronic device displays a first level data set 210 that includes general selection options for the user. Some, if not all, of the elements displayed in the first level data set 210 are first level filter criteria for the portable electronic device. To initiate a filter and to begin the process of locating a desired song, the user selects one of the first level filter criteria in the first level data set 210. The filter criteria in the first level data set 210 are also referred to herein as “general selection options.” The first view 202 also includes contextual navigation information 218. As shown, the contextual navigation information 218 includes multiple icons 220a-d. Preferably, the icons perform at least two functions: 1) the icons 220a-d provide contextual navigation information to the user about where he or she is located within the navigational structure of the user interface and 2) the icons 220a-d act as selectable contextual navigation filter criteria to provide improved navigation capabilities.

Preferably, the icons provide visual feedback to the user relating to the view that is being displayed by the user interface. For example, the first view 202 shows a highlighted arrow icon 220a informing the user that he or she is currently viewing the top level or first level data set 210. The visual feedback may be provided by modifying one of the icons, such as icon 220a, in any manner that distinguishes it from the other icons 220b-d. For example, the icon may be highlighted, subjected to a change of color, made larger, or placed within a geometric shape. The second view 204 shows a highlighted artist icon 220b informing the user that he or she is viewing artist information. Moreover, because the icons 220a-d are displayed linearly, it is clear that the artist icon in this example is associated with the second level data set 212 because it is the second icon in the linear progression. This type of linear graphical representation is sometimes referred to as a “string of pearls.” In addition, each of the views 202, 204, 206 and 208 may contain a title 222 to help provide the user with information about where he or she is located within the navigational structure of the user interface.

The selection of a filter criterion from the first level data set 210 may cause the portable electronic device to display the second view 204 with a second level data set 212. In addition, the second view 204 preferably also includes a highlighted icon, such as icon 220b, to provide visual feedback to the user of his or her current location with the portable electronic device data structure. The icons 220a-d also preferably act as selectable contextual navigation filter criteria for use in moving between views. The second level data set 212 either may be a sorted display of the first level data set 210 or it may be a subset of the first level data set 210. In either case, the second level data set 212 is associated with the selected filter criterion (general selection options and/or contextual navigation selection options) from the first level data set 210. Like the first level data set 210, the second level data set 212 also includes displayed elements that act as filter criteria for the portable electronic device. Also like the first level data set 210, the filter criteria in the second level data set 212 are also referred to herein as “general selection options.”

The selection of a filter criterion from the second level data set 212 may cause the portable electronic device to display the third view 206 with a third level data set 214. In addition, the third view 204 preferably also includes a highlighted icon, such as the CD icon 220c, to provide visual feedback to the user of his or her current location with the portable electronic device data structure. The icons 220a-d also preferably act as selectable contextual navigation filter criteria for use in moving between views. The third level data set 214 is preferably a subset of the second level data set 212 based on the selected filter criterion (general selection options and/or contextual navigation selection options) from the second level data set 212. Like the first level data set 210 and the second level data set 212, the third level data set 214 also includes displayed elements that act as filter criteria for the portable electronic device. Also like the first level data set 210 and second level data set 212, the filter criteria in the third level data set 214 are also referred to herein as “general selection options.”

The selection of a filter criterion from the third level data set 214 may cause the portable electronic device to display the fourth view 208 with a fourth level data set 216. Whereas the first level data set 210, second level data set 212 and third level data set 214 each included categories or groups, the fourth level data set of FIG. 2 includes singular data elements. In other words, while the other data sets included lists of categories and groups of songs, the fourth level data set includes a list of songs. A user can play a song by selecting it from the fourth level data set 216. Also, the user interface also preferably provides additional filtering options based on other factors not necessarily listed in any of the data sets. For example, the user interface preferably includes the option of narrowing search results based on at least one additional statistic criterion. Such additional criteria may include, for example, most played songs, least played songs, mood, rating, genre, or the like.

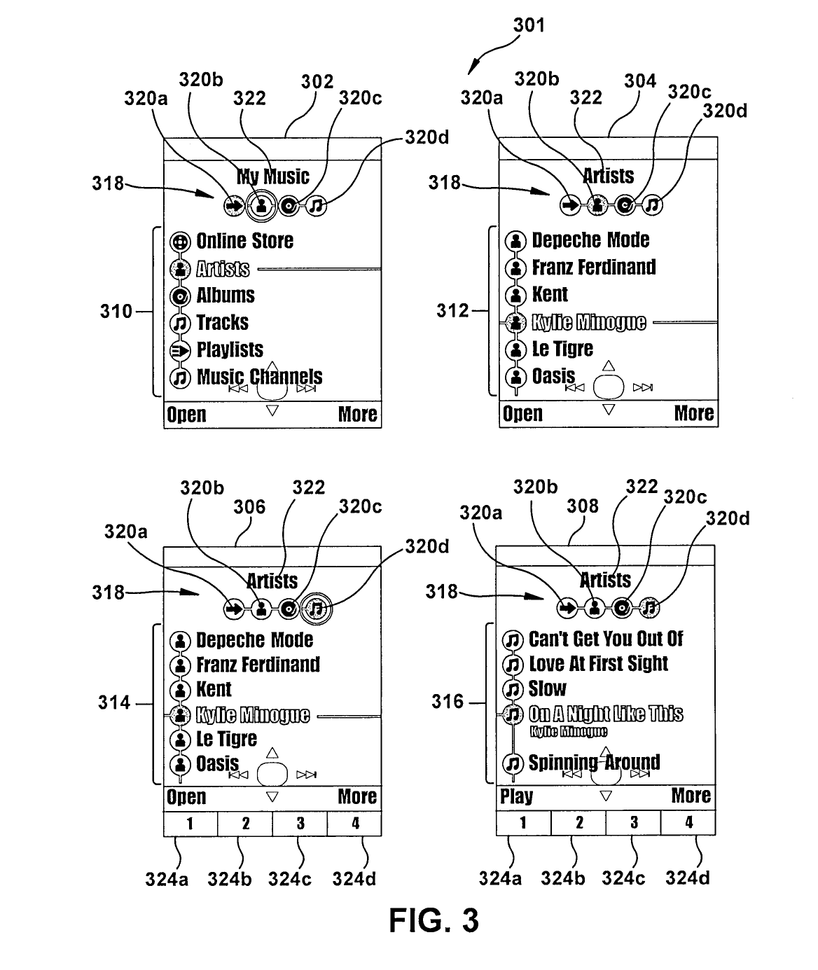

Turning next to FIG. 3, additional functionality of the improved navigation user interface is illustrated. Because the user interface preferably includes navigation filter criteria, e.g., contextual navigation icon filters, the user interface is preferably capable of providing users with the ability to jump between views that are more than one level apart. FIG. 3 illustrates the presently preferred method of implementing this type of navigation. Like FIG. 2, the views (collectively 301) of FIG. 3 include various level filter criteria (310, 312, 314 and 316) as well as contextual navigation filter criteria 320a-d. Unlike FIG. 2, FIG. 3 provides an example of how a user might skip from a view of a second level data set to a view of a fourth level data set.

To navigate using the user interface of FIG. 3, the user can select a first level filter criterion from a first view 302 to cause the user interface to display a second view 304. The example of FIG. 3 illustrates the selection of “Artists” to cause the second view to display a second level data set including a listing of artists. As shown at 306 (another picture of the second view), the user can select an artist (a second level filter criterion) and also select the song icon 220d (a navigation filter criterion) to cause the user interface to display all songs associated with the selected artist. The resulting data set can be described as a fourth level data set. In one embodiment, the selection of the second level filter criterion (general selection) and the selection of the navigation filter criterion (contextual navigation selection) are accomplished using different types of user input. The user input for the navigation filter criterion may be, for example, at least one of a number key, a letter key or a touchscreen entry. In one presently preferred embodiment for a mobile phone portable electronic device, the navigation filter criterion is selected by pressing one of the numbers 1-4 on the phone keypad. The selections can also be made, for example, using a joystick, pointer and switch, a soft key, a touch screen and finger or stylus, etc., whether on a mobile phone other portable electronic device.

Moreover, a user viewing any level data set view 308 could use the navigation filter criteria to jump to higher data levels. For example, a user viewing a fourth level data set consisting of a list of songs could select the arrow icon 320a to return to the first level data set view 302.

Still referring to FIG. 3, it is possible to combine multiple filter commands at other level views as well. The number of levels that exist for navigation using the user interface depends on the complexity of the underlying data structure and is not limited by the present invention. The user interface of the present invention preferably permits the user to execute both a general selection and a contextual navigation selection from one of a plurality of different views. The results of the selection filters may vary depending on the view from which the user executes multiple filters. For example, if the user executes a general selection and a contextual navigation selection from a second level data set view, the user interface will filter the underlying data set based on both the general selection and the contextual navigation selection. If the user executes a general selection and a contextual navigation from a first level data set view, however, the user interface may execute the general selection and use the contextual navigation to sort the results of the general selection filter. In addition, the user interface may execute the contextual navigation selection and use the general selection to sort the results of the contextual navigation selection.

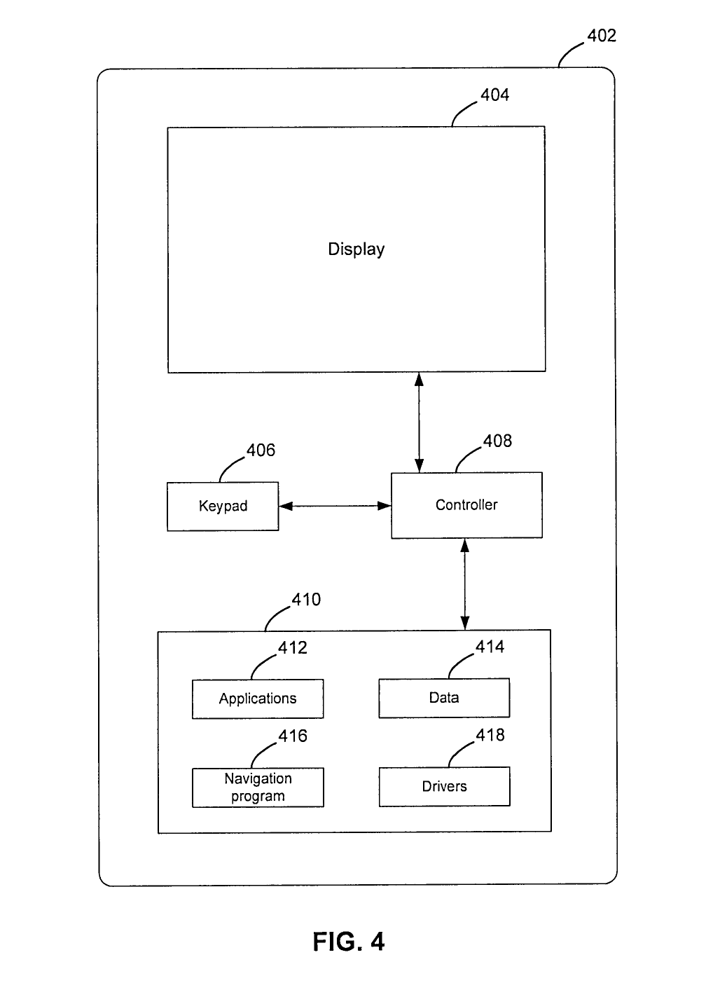

Turning next to FIG. 4, provided is a diagrammatic illustration of an exemplary portable electronic device on which the present invention may be carried out. The portable electronic device 402 includes a display 404, keypad 406, controller 408 and memory 410. In the memory 410 are stored applications 412 for running the portable electronic device 402, data, such as the data structure accessed by the user interface according to the present invention, a navigation program 416 and applicable drivers 418. The display 404 is any display capable of displaying any of the views of FIGS. 1-3. The keypad is any key-based user input device. Where the portable electronic device 402 is a mobile phone, the keypad 406 may be a numerical keypad. In addition, the portable electronic device may include additional user input mechanisms, such as a joystick, wheel, touchscreen, etc. The controller 408 controls the user interface and flow of data. As will be understood by those skilled in the art, the controller 108 may be implemented as one or combinations of the following: programmable circuit, integrated circuit, memory and I/O circuits, an application specific integrated circuit, microcontroller, complex programmable logic device, field programmable gate arrays, other programmable circuits, or the like.

The navigation program, in conjunction with the controller 408 and memory 410, causes the portable electronic device 402 to be configured to perform the functions described with reference to FIGS. 2 and 3.

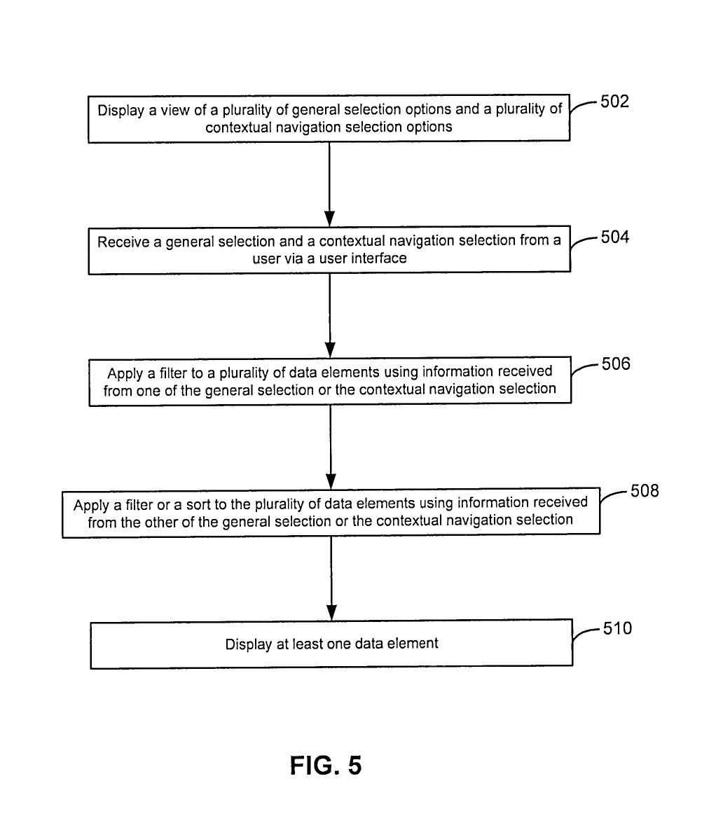

Turning next to FIG. 5 a flow chart illustrating a method according to the present invention for displaying data elements on a portable electronic device is provided. Flow begins at process block 502, wherein a view of a plurality of general selection options and a plurality of contextual navigation selection options are displayed. Flow then continues to process block 504. At process block 504, a general selection, and a contextual navigation selection are received from a user via a user interface. Progression then flows to process block 506 wherein a filter is applied to a plurality of data elements using information received from the general selection or the contextual navigation selection. Flow then progresses to process block 508 wherein a filter or a sort is applied to the plurality of data elements using information received from the other of the general selection or the contextual navigation selection. Flow then continues to process block 510 wherein at least one data element is displayed.

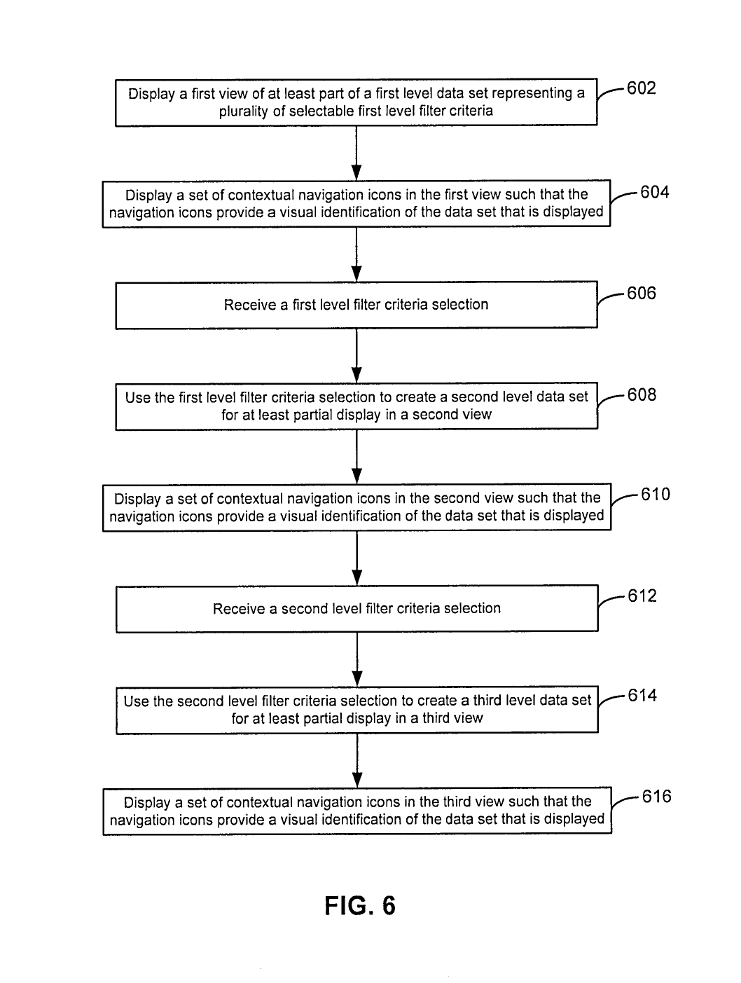

Turning next to FIG. 6, a flow chart illustrating a method according to the present invention for improving navigation through a multilevel data set on a portable electronic device is provided. Flow begins at process block 602, wherein a first view of at least part of a first level data set representing a plurality of selectable first level filter criteria is displayed. Flow then continues to process block 604. At process block 604, a set of contextual navigation icons is displayed in the first view such that the navigation icons provide a visual identification of the data set that is displayed. Progression then flows to process block 606 wherein a first level filter criteria selection is received. Flow then continues to process block 608 wherein the first level filter criteria selection is used to create a second level data set for at least partial display in a second view. Progression then flows to process block 610 wherein a set of contextual navigation icons is displayed in the second view such that the navigation icons provide a visual identification of the data set that is displayed. Flow then continues to process block 612 wherein a second level filter criteria selection is received. Progression then flows to process block 614 wherein the second level filter criteria selection is used to create a third level data set for at least partial display in a third view. Flow then progresses to process block 614 wherein a set of contextual navigation icons is displayed in the third view such that the navigation icons provide a visual identification of the data set that is displayed.

While the present invention has been described primarily with reference to digital music, digital video and digital image files, the present invention is not intended to be so limited. One of ordinary skill in the art will recognize that the user interface of the present invention can be used with virtually any relational, multilevel data structure. As will be appreciated by one of ordinary skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A user interface for a portable electronic device comprising:
a first view for displaying a plurality of contextual navigation filter criteria and at least part of first level data set representing a plurality of selectable first level filter criteria;
a second view for displaying the plurality of selectable contextual navigation filter criteria and at least part of a second level data set representing a plurality of selectable second level filter criteria;
a third view for displaying the plurality of selectable contextual navigation filter criteria and at least part of a third level data set representing a plurality of selectable third level filter criteria; and
a fourth view for displaying at least part of a fourth level data set;
wherein the selection by a user of one of the plurality of second level filter criteria from the second view causes the user interface to display the third view; and
wherein the selection by a user of one of the plurality of second level filter criteria from the second view and at least one of the plurality of navigation filter criteria causes the user interface to display all or part of a subset of the third level data set resulting from application of the second level filter criterion and the navigation filter criterion.

2. The user interface of claim 1 wherein the selectable contextual navigation filter criteria provide the user with an identification of the type of data set being displayed.

3. The user interface of claim 1 wherein the subset of the third level data set resulting from application of the second level filter criterion and the navigation filter criterion comprises the fourth level data set.

4. The user interface of claim 1 wherein the second level data set is a superset of the third level data set and the third level data set is a superset of the fourth level data set.

5. The user interface of claim 1 wherein the contextual navigation filter criteria comprise icons.

6. The user interface of claim 5 wherein at least three of the icons represent the first level data set, the second level data set and third level data set.

7. The user interface of claim 5 wherein the icons provide visual feedback relating to the view displayed.

8. The user interface of claim 5 wherein the icons are displayed linearly.

9. The user interface of claim 1 wherein the selection of one of the plurality of second level filter criteria and the selection of one of the plurality of navigation filter criteria are accomplished using different types of user input.

10. The user interface of claim 9 wherein the type of input for the selection of one of the plurality of navigation filter criteria is at least one of; a number key, a letter key, soft key or a touchscreen.

11. The user interface of claim 1 wherein the at least part one of the data sets is stored locally in the portable electronic device.

12. The user interface of claim 1 wherein the at least part of one of the data sets is stored remotely on a remote computer readable medium accessible to the portable electronic device.

13. The user interface of claim 1 wherein the portable electronic device is at least one of: a portable digital music player, a mobile phone or a PDA.

14. The user interface of claim 1 wherein the displayed data is limited by at least one additional player statistics criterion.

15. The user interface of claim 14 wherein the additional player statistics criterion is at least one of: most played, not played, mood or rating.

16. The user interface of claim 1 wherein the selected filter criteria are applied to metadata associated with data files.

17. The user interface of claim 1 wherein the selection of element of at least one data set causes the portable electronic device to open a data file.

18. The user interface of claim 1 wherein a data file associated with at least one of the data sets is selected from the group consisting essentially of: audio files, image files, video files and combinations thereof.

19. A program stored on a machine readable medium, the program being suitable for use in a portable electronic device, wherein when the program is loaded in memory in the portable electronic device and executed, the program causes the portable electronic device to be configured at least in part:
(a) to display a view of a plurality of general selection options and a plurality of contextual navigation selection options;
(b) to receive a general selection and a contextual navigation selection from a user via a user interface;
(c) to apply a filter to a plurality of data elements using information received from one of the general selection or the contextual navigation selection;
(d) to apply a filter or a sort to the plurality of data elements using information received from the other of the general selection or the contextual navigation selection; and
(e) to display at least one data element representing results achieved from performing (c) and (d).

20. The program of claim 19 wherein the selectable contextual navigation selection options provide the user with an identification of the type of data set being displayed.

21. The program of claim 19 wherein the contextual navigation selection options comprise icons.

22. The program of claim 21 wherein at least three of the icons represent at least three levels of data sets and wherein at least the third level is a subset of the second level.

23. The program of claim 21 wherein the icons provide visual feedback relating to the view displayed.

24. The program of claim 21 wherein the icons are displayed linearly.

25. The program of claim 19 wherein the general selection and the contextual navigation selection are received using different types of user input.

26. The program of claim 25 wherein the type of input for the contextual navigation selection is at least one of: a number key, a letter key, a soft key or a touchscreen.

27. The program of claim 19 wherein at least one of the plurality of data elements is stored locally in the portable electronic device.

28. The program of claim 19 wherein at least one of the plurality of data elements is stored remotely on a remote computer readable medium accessible via the portable electronic device.

29. The program of claim 19 wherein the portable electronic device is at least one of: a portable digital music player, a mobile phone or a PDA.

30. The program of claim 19 wherein the displayed data is limited by at least one additional player statistics criterion.

31. The program of claim 30 wherein the additional player statistics criterion is at least one of: most played, not played, mood or rating.

32. The user interface of claim 19 wherein at least one filter is applied to metadata associated with data files.

33. The user interface of claim 19 wherein the selection of at least one data element from the results achieved by performing (c) and (d) causes the portable electronic device to open a data file.

34. The user interface of claim 33 wherein the data file is selected from the group consisting essentially of: audio files, image files, video files and combinations thereof.

35. A program stored on a machine readable medium, the program being suitable for use in a portable electronic device, wherein when the program is loaded in memory in the portable electronic device, the program improves navigation through a multilevel data set on a portable electronic device by causing the portable electronic device to be configured:
to display a first view of at least part of a first level data set representing a plurality of selectable first level filter criteria;
to receive a first level filter criteria selection;
to use the first level filter criteria selection to create a second level data set for at least partial display in a second view;
to receive a second level filter criteria selection;
to use the second level filter criteria selection to create a third level data set for at least partial display in a third view;
to display a set of contextual navigation icons in the first view, the second view and the third view, wherein the set of contextual navigation icons comprises an icon associated with each of the views; and
to modify the appearance of the contextual navigation icons for each of the views to provide a visual identification of the data set that is displayed.

36. The program of claim 35 wherein the program causes the portable electronic device to be further configured to use the third level filter criteria selection to create a fourth level data set for at least partial display in a fourth view.

37. The program of claim 35 wherein the program causes the portable electronic device to be further configured to display the set of contextual navigation icons in the fourth view.

38. The method of claim 35 wherein the set of contextual navigation icons is displayed in a linear pattern.

39. The method of claim 35 wherein modifying the appearance of the contextual navigation icons comprises at least one of: highlighting one of the icons, changing the color of one of the icons, making one of the icons larger, or placing one of the icons within a geometric shape.

40. The program of claim 35 wherein the portable electronic device is at least one of: a portable digital music player, a mobile phone or a PDA.

41. A method for displaying data elements on a portable electronic device comprising:
(a) displaying a view of a plurality of general selection options and a plurality of contextual navigation selection options;
(b) receiving a general selection and a contextual navigation selection from a user via a user interface;
(c) applying a filter to a plurality of data elements using information received from one of the general selection of the contextual navigation selection;
(d) applying a filter or a sort to the plurality of data elements using information received from the other of the general selection or the contextual navigation selection; and
(e) displaying at least one data element representing results achieved from performing (c) and (d).

42. A method for improving navigation through a multilevel data set on a portable electronic device comprising:
displaying a first view of at least part of a first level data set representing a plurality of selectable first level filter criteria;
receiving a first level filter criteria selection;
using the first level filter criteria selection to create a second level data set for at least partial display in a second view;
